(19) United States
(12) Patent Application Publication
(10) Pub. No.: US 2016/0055799 A1
(43) Pub. Date: Feb. 25, 2016

(54) ORGANIC LIGHT-EMITTING DIODE DISPLAY DEVICE AND METHOD OF OPERATING THE SAME

(71) Applicant: Samsung Display Co., Ltd., Yongin-City (KR)

(72) Inventors: Ji-Hye Eom, Hwaseong-si (KR); Baek-Woon Lee, Yongin-si (KR)

(21) Appl. No.: 14/599,145

(22) Filed: Jan. 16, 2015

(30) Foreign Application Priority Data
Aug. 20, 2014 (KR) 10-2014-0108218

(51) Int. Cl. G09G 3/32

(52) U.S. Cl. CPC G09G 3/3258; G09G 3/3291; G09G 2310/0262; G09G 2310/027; G09G 2320/0219; G09G 2320/0233; G09G 2320/029

(57) ABSTRACT

An organic light-emitting diode (OLED) display and a method of operating the same are disclosed. In one aspect, the display includes a plurality of pixels each including a pixel circuit and produces grayscale values by adjusting an emission duty based at least in part on image data. The method comprises calculating a voltage drop of a power supply voltage at each of the pixel circuits based at least in part on the image data and extracting a luminance decrement corresponding to the voltage drop for each pixel circuit based at least in part on a voltage-luminance characteristic of the pixels. The method also comprises increasing the emission duty for each pixel based at least in part on the luminance decrement, and driving the pixels based at least in part on the increased emission duty.

### CROSS-REFERENCE TO RELATED APPLICATIONS

This application claims priority under 35 USC §119 to Korean Patent Application No. 10-2014-0108218, filed on Aug. 20, 2014 in the Korean Intellectual Property Office (KIPO), the contents of which are incorporated herein in its entirety by reference.

### BACKGROUND

1. Field

The described technology generally relates to organic light-emitting diode displays and method of operating the same.

2. Description of the Related Technology

An active matrix type of OLED display can be driven by an analog driving method or a digital driving method. The analog driving method produces grayscale values of data with variable voltage levels. Making an integrated circuit (IC) driver implementing the analog driving method has proven to be difficult for larger and higher resolution panels. The digital driving method produces grayscale values by causing an OLED to emit light with a variable time duration. Compared to the analog driving method, a simpler IC structure can be used to implement the digital driving method. Therefore, the digital driving method can be more suitable for high resolution panels. Also, the digital driving method operates based on on- and off-states of a driving thin film transistor (TFT) that can result in less image quality deterioration due to a smaller variation of TFT characteristics. Therefore, the digital driving method can be more suitable for larger size panels.

### SUMMARY OF CERTAIN INVENTIVE ASPECTS

One inventive aspect is a method of operating an OLED display that can accurately compensate a voltage drop of a power supply voltage in the OLED display driven by a digital driving method.

Another aspect is an OLED display that can accurately compensate a voltage drop of a power supply voltage in the OLED display driven by a digital driving method.

Another aspect is a method of operating an OLED display that produces grayscale values by adjusting an emission duty according to image data. In the method, a voltage drop of a power supply voltage at each of a plurality of pixels included in the OLED display is calculated based on the image data, a luminance decrement corresponding to the voltage drop of the power supply voltage with respect to each of the plurality of pixels is extracted based on a voltage-luminance characteristic of the plurality of pixels, the emission duty with respect to each of the plurality of pixels is increased based on the luminance decrement, and the plurality of pixels are driven based on the increased emission duty.

In some embodiments, the emission duty is increased in proportion to the luminance decrement.

In some embodiments, the emission duty is increased such that, which respect to each of the plurality of pixels, a multiplication of a luminance decreased by the luminance decrement by the increased emission duty is substantially the same as a multiplication of a reference luminance and a reference emission duty.

In some embodiments, to calculate the voltage drop of the power supply voltage at each of the plurality of pixels, a display panel of the OLED display is divided into a plurality of blocks, a plurality of currents respectively provided to the plurality of blocks can be calculated based on the image data, the voltage drop of the power supply voltage at each of the plurality of blocks can be calculated based on the plurality of currents, and the voltage drop of the power supply voltage at each of the plurality of pixels can be calculated by interpolating the calculated voltage drop of the power supply voltage at each of the plurality of blocks.

In some embodiments, the voltage drop of the power supply voltage is calculated on a frame-by-frame basis.

In some embodiments, the voltage drop of the power supply voltage is calculated on a subframe-by-subframe basis.

In some embodiments, to extract the luminance decrement corresponding to the voltage drop of the power supply voltage, the luminance decrement corresponding to the voltage drop of the power supply voltage is obtained from a lookup table storing the voltage-luminance characteristic.

In some embodiments, to extract the luminance decrement corresponding to the voltage drop of the power supply voltage, the luminance decrement corresponding to the voltage drop of the power supply voltage with respect to a red pixel among the plurality of pixels is obtained from a first lookup table storing the voltage-luminance characteristic of the red pixel, the luminance decrement corresponding to the voltage drop of the power supply voltage with respect to a green pixel among the plurality of pixels is obtained from a second lookup table storing the voltage-luminance characteristic of the green pixel, and the luminance decrement corresponding to the voltage drop of the power supply voltage with respect to a blue pixel among the plurality of pixels is obtained from a third lookup table storing the voltage-luminance characteristic of the blue pixel.

In some embodiments, to extract the luminance decrement corresponding to the voltage drop of the power supply voltage, a voltage-luminance characteristic parameter for each of the plurality of pixels is extracted from a voltage-luminance characteristic storing unit that stores the voltage-luminance characteristic parameter for each of the plurality of pixels, and the luminance decrement for each of the plurality of pixels is calculated based on the extracted voltage-luminance characteristic parameter for each of the plurality of pixels.

In some embodiments, the voltage-luminance characteristic parameter for each of the plurality of pixels includes a threshold voltage of an organic light emitting diode included in each of the plurality of pixels and a voltage-luminance characteristic coefficient of each of the plurality of pixels.

In some embodiments, the luminance decrement for each of the plurality of pixels is calculated using an equation, “L=K*(ELVDD−VTH)̂2”, where L represents a luminance of each of the plurality of pixels, K represents a voltage-luminance characteristic coefficient of each of the plurality of pixels, ELVDD represents the power supply voltage, and VTH represents a threshold voltage of an organic light emitting diode included in each of the plurality of pixels.

In some embodiments, to increase the emission duty with respect to each of the plurality of pixels based on the luminance decrement, a scale factor for the emission duty is calculated based on the luminance decrement, and the emission duty is increased by multiplying the emission duty by the calculated scale factor with respect to each of the plurality of pixels.

In some embodiments, the scale factor is calculated by dividing a reference luminance by a luminance decreased by the luminance decrement from the reference luminance.

In some embodiments, when the scale factor for at least one of the plurality of pixels is greater than a predetermined value, the scale factor for all of the plurality of pixels is decreased.

Another aspect is an OLED display that produces grayscale values by adjusting an emission duty according to image data. The OLED display includes a display panel including a plurality of pixels, a voltage drop calculating unit configured to calculate a voltage drop of a power supply voltage at each of the plurality of pixels based on the image data, a voltage-luminance characteristic storing unit configured to store a voltage-luminance characteristic of the plurality of pixels, an emission duty adjusting unit configured to extract a luminance decrement corresponding to the voltage drop of the power supply voltage with respect to each of the plurality of pixels based on the voltage-luminance characteristic, and to increase the emission duty with respect to each of the plurality of pixels based on the luminance decrement, and a driving unit configured to drive the plurality of pixels based on the increased emission duty.

In some embodiments, the emission duty adjusting unit increases the emission duty such that, which respect to each of the plurality of pixels, a multiplication of a luminance decreased by the luminance decrement by the increased emission duty is substantially the same as a multiplication of a reference luminance and a reference emission duty.

In some embodiments, the voltage-luminance characteristic storing unit includes a lookup table that stores the voltage-luminance characteristic of the plurality of pixels.

In some embodiments, the voltage-luminance characteristic storing unit includes a first lookup table that stores the voltage-luminance characteristic of a red pixel among the plurality of pixels, a second lookup table that stores the voltage-luminance characteristic of a green pixel among the plurality of pixels, and a third lookup table that stores the voltage-luminance characteristic of a blue pixel among the plurality of pixels.

In some embodiments, the voltage-luminance characteristic storing unit stores a voltage-luminance characteristic parameter for each of the plurality of pixels.

In some embodiments, the emission duty adjusting unit calculates a scale factor for the emission duty based on the luminance decrement, and increases the emission duty by multiplying the emission duty by the calculated scale factor with respect to each of the plurality of pixels.

Another aspect is a method of operating an organic light-emitting diode (OLED) display that includes a plurality of pixels each including a pixel circuit and produces grayscale values by adjusting an emission duty based at least in part on image data. The method comprises calculating a voltage drop of a power supply voltage at each of the pixel circuits based at least in part on the image data, extracting a luminance decrement corresponding to the voltage drop for each pixel circuit based at least in part on a voltage-luminance characteristic of the pixels, increasing the emission duty for each pixel based at least in part on the luminance decrement, and driving the pixels based at least in part on the increased emission duty.

In the above method, the emission duty is increased to be substantially proportional to the luminance decrement.

In the above method, the emission duty is increased such that a product of a luminance decreased by the luminance decrement and the increased emission duty is substantially the same as a product of a reference luminance and a reference emission duty for each pixel.

In the above method, the calculating includes dividing a display panel of the OLED display into a plurality of blocks, calculating a plurality of currents respectively provided to the blocks based at least in part on the image data, calculating the voltage drop at each of the blocks based at least in part on the currents, and interpolating the calculated voltage drop at each block so as to calculate the voltage drop at each pixel circuit.

In the above method, the voltage drop is calculated on a frame-by-frame basis.

In the above method, the voltage drop is calculated on a subframe-by-subframe basis.

In the above method, the extracting includes obtaining the luminance decrement corresponding to the voltage drop from a lookup table storing the voltage-luminance characteristic.

In the above method, the extracting includes obtaining a first luminance decrement corresponding to the voltage drop of a red pixel among the pixels from a first lookup table storing the voltage-luminance characteristic of the red pixel. In the above method, the extracting also includes obtaining a second luminance decrement corresponding to the voltage drop of a green pixel among the pixels from a second lookup table storing the voltage-luminance characteristic of the green pixel. In the above method, the extracting also includes obtaining a third luminance decrement corresponding to the voltage drop of a blue pixel among the pixels from a third lookup table storing the voltage-luminance characteristic of the blue pixel.

In the above method, the extracting includes extracting a voltage-luminance characteristic parameter for each pixel from a voltage-luminance characteristic storing unit that stores the voltage-luminance characteristic parameter for each pixel. In the above method, the extracting also includes calculating the luminance decrement for each pixel based at least in part on the extracted voltage-luminance characteristic parameter for each pixel.

In the above method, each pixel includes an OLED. In the above method, for each pixel, the voltage-luminance characteristic parameter includes a threshold voltage of the OLED and a voltage-luminance characteristic coefficient of each pixel.

In the above method, the luminance decrement for each pixel is calculated using an equation, “L=K*(ELVDD−VTH)̂2”, where L represents a luminance of each pixel, K represents a voltage-luminance characteristic coefficient of each pixel, ELVDD represents the power supply voltage, and VTH represents a threshold voltage of an OLED included in each pixel.

In the above method, the increasing includes calculating a scale factor for the emission duty based at least in part on the luminance decrement, and multiplying the emission duty by the calculated scale factor with respect to each pixel so as to increase the emission duty.

The above method further comprises dividing a reference luminance by a luminance, decreased by the luminance decrement, so as to calculate the scale factor.

In the above method, the increasing further includes, when the scale factor for at least one of the pixels is greater than a predetermined value, decreasing the scale factor for all of the pixels.

Another aspect is an organic light-emitting diode (OLED) display, comprising a display panel including a plurality of pixels each including a pixel circuit, a voltage drop calculator configured to calculate a voltage drop of a power supply voltage at each pixel circuit based at least in part on image data, and a voltage-luminance characteristic storing unit configured to store a voltage-luminance characteristic of the pixels. The display also comprises an emission duty adjuster configured to i) extract a luminance decrement corresponding to the voltage drop of the power supply voltage with respect to each pixel circuit based at least in part on the voltage-luminance characteristic and ii) increase the emission duty with respect to each pixel based at least in part on the luminance decrement. The display also comprises a driver configured to drive the pixels based at least in part on the increased emission duty.

In the above display, the emission duty adjuster is further configured to increase the emission duty such that, with respect to each pixel, a product of a luminance decreased by the luminance decrement and the increased emission duty is substantially the same as a product of a reference luminance and a reference emission duty.

In the above display, the voltage-luminance characteristic storing unit includes a lookup table configured to store the voltage-luminance characteristic of the pixels.

In the above display, the pixels include red, green, and blue pixels, wherein the voltage-luminance characteristic storing unit includes a first lookup table configured to store a first voltage-luminance characteristic of the red pixels, a second lookup table configured to store a second voltage-luminance characteristic of the green pixels, and a third lookup table configured to store a third voltage-luminance characteristic of the blue pixels.

In the above display, the voltage-luminance characteristic storing unit is further configured to store a voltage-luminance characteristic parameter for each pixel.

In the above display, the emission duty adjuster is further configured to i) calculate a scale factor of the emission duty based at least in part on the luminance decrement and ii) multiply the emission duty by the calculated scale factor with respect to each pixel so as to increase the emission duty.

### BRIEF DESCRIPTION OF THE DRAWINGS

FIG. 1 is a flowchart illustrating a method of operating an OLED display in accordance with example embodiments.

FIG. 2 is a diagram for describing an example of calculating a voltage drop of a power supply voltage in accordance with example embodiments.

FIG. 3 is a diagram for describing an example of extracting a luminance decrement corresponding to a voltage drop of a power supply voltage in accordance with example embodiments.

FIG. 4 is a diagram for describing an example of increasing an emission duty based on a luminance decrement in accordance with example embodiments.

FIG. 5 is a flowchart illustrating a method of operating an OLED display in accordance with example embodiments.

FIG. 6 is a diagram for describing an example of extracting a luminance decrement corresponding to a voltage drop of a power supply voltage in a method of FIG. 5.

FIG. 7 is a flowchart illustrating a method of operating an OLED display in accordance with example embodiments.

FIG. 8 is a diagram for describing an example of extracting a luminance decrement corresponding to a voltage drop of a power supply voltage in the method of FIG. 7.

FIG. 9 is a flowchart illustrating a method of operating an OLED display in accordance with example embodiments.

FIG. 10 is a block diagram illustrating an OLED display in accordance with example embodiments.

FIG. 11 is a block diagram illustrating an electronic device including an OLED display in accordance with example embodiments.

### DETAILED DESCRIPTION OF CERTAIN INVENTIVE EMBODIMENTS

In a method of digitally driving data to pixel circuits, the power supply voltage supplied to each pixel is simultaneously applied to the OLED by a switching transistor. Hence, pixel luminance can be greatly impacted by power supply voltage drops (e.g., an IR drop).

The example embodiments are described more fully hereinafter with reference to the accompanying drawings. Like or similar reference numerals refer to like or similar elements throughout. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

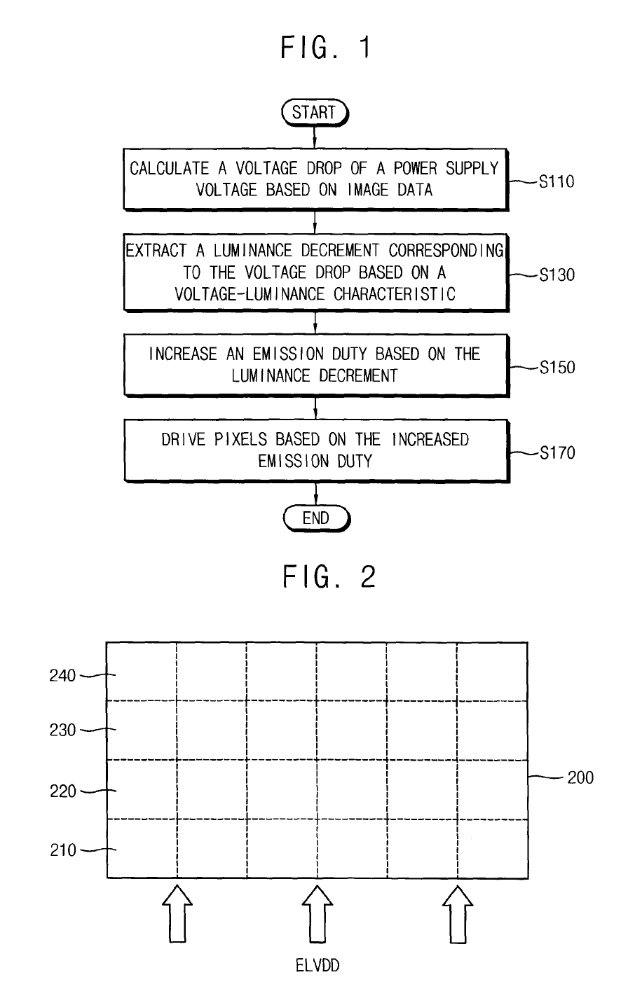

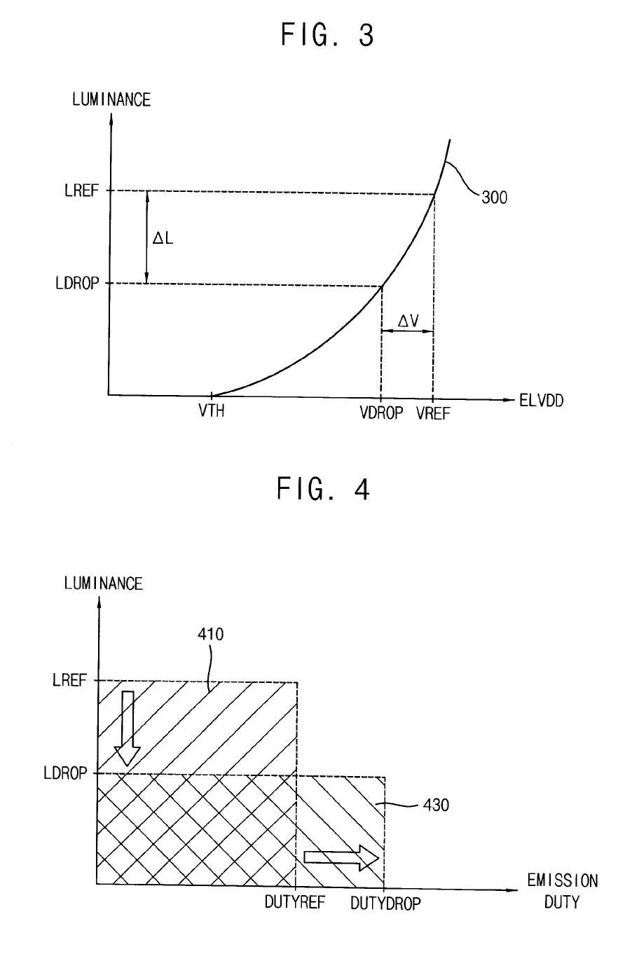

FIG. 1 is a flowchart illustrating a method of operating an OLED display in accordance with example embodiments. FIG. 2 is a diagram for describing an example of calculating a voltage drop of a power supply voltage. FIG. 3 is a diagram for describing an example of extracting a luminance decrement corresponding to a voltage drop of a power supply voltage. FIG. 4 is a diagram for describing an example of increasing an emission duty based on a luminance decrement.

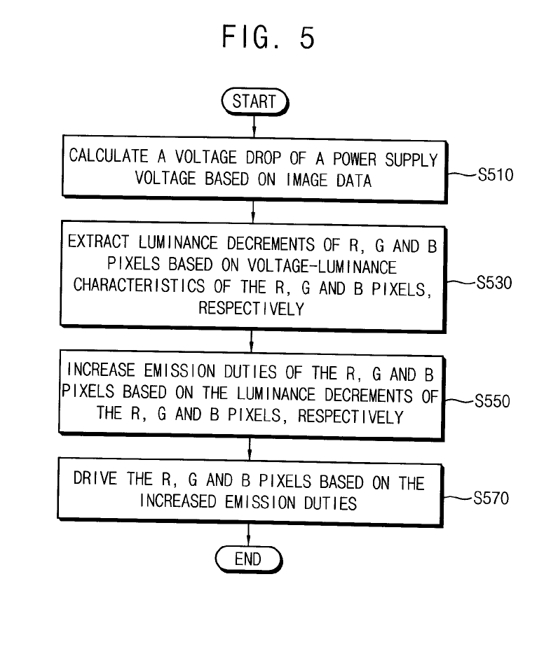

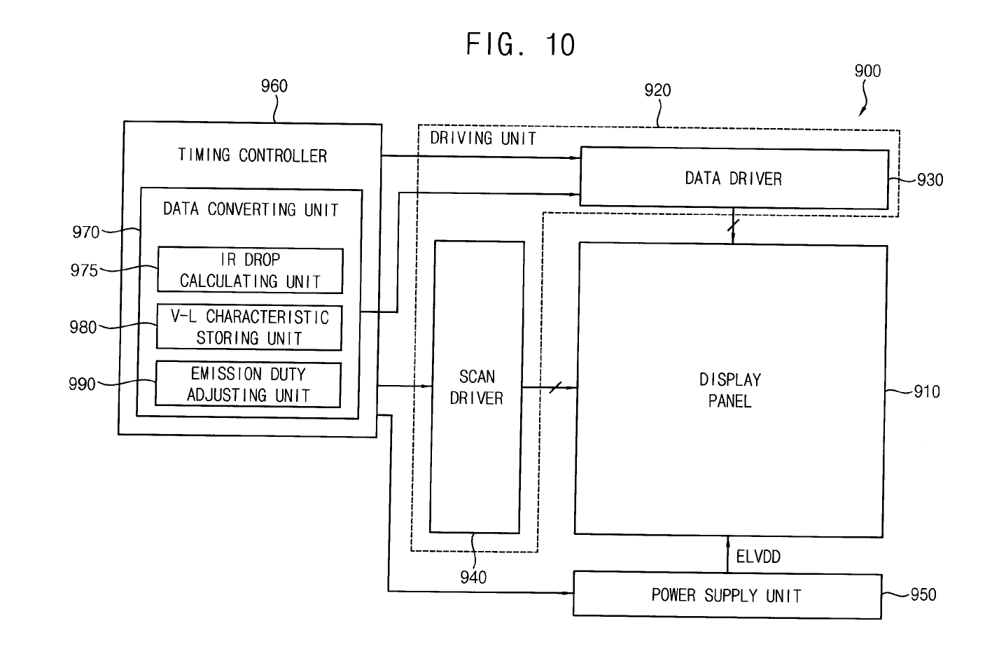

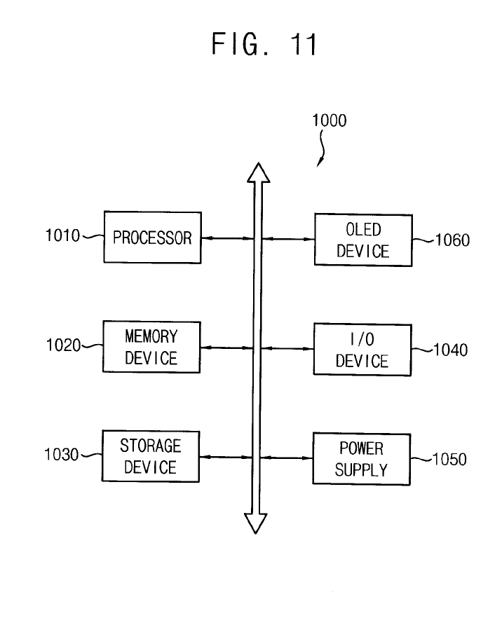

In some embodiments, the FIG. 1 procedure is implemented in a conventional programming language, such as C or C++ or another suitable programming language. The program can be stored on a computer accessible storage medium of the OLED display 900 (see FIG. 10), for example, a memory (not shown) of the OLED display 900 or a timing controller 960 (see FIG. 10). In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 1. The description of this paragraph applies to the embodiments shown in FIGS. 5, 7, and 9.

Referring to FIG. 1, an OLED display calculates a voltage drop (e.g., an IR drop) of a power supply voltage at a pixel circuit of each of a plurality of pixels included in the OLED display based at least in part on the image data (S110). Each pixel includes a pixel circuit. The OLED display can be a digital driving type display that produces grayscale values by adjusting an emission duty according to the image data. Here, the emission duty can represent a ratio of an emission period to one frame period. Further, the image data can represent RGB input data provided from an external device to the OLED display, or can represent the RGB input data after a gamma correction operation is performed on the RGB input data. In some embodiments, the OLED display calculates the voltage drop of the power supply voltage at each pixel on a frame-by-frame basis. In some embodiments, the OLED display calculates the voltage drop of the power supply voltage at each pixel on a subframe-by-subframe basis.

In some embodiments, the OLED display calculates a plurality of currents respectively provided to the pixels based at least in part on the image data, and calculates the voltage drop at respective positions of a power supply line corresponding to the pixels based at least in part on the currents.

In some embodiments, as illustrated in FIG. 2, the OLED display divides a display panel 200 into a plurality of blocks 210, 220, 230 and 240, and calculates a plurality of currents respectively provided to the blocks 210, 220, 230 and 240 based at least in part on the image data. The OLED display can calculate the voltage drop of the power supply voltage ELVDD at each of the first to fourth blocks 210, 220, 230 and 240 based at least in part on the currents. For example, when the power supply voltage ELVDD is provided in a direction from the first block 210 through the second and third blocks 220 and 230 to the fourth block 240, the voltage drop of the power supply voltage ELVDD at the first block 210 is calculated by multiplying a sum of the currents provided to the first through fourth blocks 210, 220, 230 and 240 by a resistance of the power supply line at the first block 210. Further, the voltage drop of the power supply voltage ELVDD at the first block 210 can be calculated by multiplying a sum of the currents provided to the second through fourth blocks 220, 230 and 240 by the resistance of the power supply line at the second block 220 and by adding a result of the multiplication to the voltage drop of the power supply voltage ELVDD at the first block 210. The OLED display can calculate the voltage drop of the power supply voltage ELVDD at each pixel by interpolating the calculated voltage drop of the power supply voltage at respective blocks 210, 220, 230 and 240. For example, the voltage drop of the power supply voltage ELVDD at a pixel located at a boundary between the first block 210 and the second block 220 can be calculated as a middle value between the voltage drops at the first and second blocks 210 and 220 by interpolating the voltage drop of the power supply voltage ELVDD at the first block 210 and the voltage drop of the power supply voltage ELVDD at the second block 220.

The OLED display can extract a luminance decrement corresponding to the voltage drop of the power supply voltage with respect to each pixel based at least in part on a voltage-luminance characteristic of the plurality of pixels (S130). For example, as illustrated in FIG. 3, the OLED display extracts the luminance decrement for each pixel by using a voltage-luminance characteristic curve 310 indicating the voltage-luminance characteristic of the plurality of pixels. With respect to a pixel, when the power supply voltage ELVDD is dropped from a reference power supply voltage VREF (e.g., the power supply voltage ELVDD at a power supply unit) to a dropped power supply voltage VDROP by the voltage drop ΔV, the OLED display can extract a dropped luminance LDROP corresponding to the dropped power supply voltage VDROP from the voltage-luminance characteristic curve 310, and can extract the luminance decrement ΔL by subtracting the dropped luminance LDROP from a reference luminance LREF that is a luminance of the pixel when the voltage drop ΔV does not exist.

In some embodiments, the OLED display includes a lookup table that stores the voltage-luminance characteristic (or the voltage-luminance characteristic curve 310), and extracts the luminance decrement ΔL corresponding to the voltage drop ΔV of the power supply voltage ELVDD from the lookup table. In some embodiments, the lookup table stores one voltage-luminance characteristic curve 310 with respect to the plurality of pixels. In some embodiments, two or more voltage-luminance characteristic curves 310 are stored with respect to the pixels. For example, the display panel of the OLED display is divided into a plurality of blocks, and the lookup table stores a plurality of voltage-luminance characteristic curves 310 respectively corresponding to the plurality of blocks.

In some embodiments, the OLED display includes a first lookup table that stores the voltage-luminance characteristic of a red pixel, a second lookup table that stores the voltage-luminance characteristic of a green pixel, and a third lookup table that stores the voltage-luminance characteristic of a blue pixel. The OLED display can obtain the luminance decrement corresponding to the voltage drop of the power supply voltage with respect to the red pixel from the first lookup table. The OLED display can obtain the luminance decrement corresponding to the voltage drop of the power supply voltage with respect to the green pixel from the second lookup table. And the OLED display can obtain the luminance decrement corresponding to the voltage drop of the power supply voltage with respect to the blue pixel from the third lookup table. In some embodiments, each lookup table stores one or more voltage-luminance characteristic curves with respect to a corresponding one of the red, green and blue pixels.

In some embodiments, the OLED display includes a voltage-luminance characteristic storing unit that stores a voltage-luminance characteristic parameter for each pixel. The OLED display can extract the voltage-luminance characteristic parameter for each pixel from the voltage-luminance characteristic storing unit, and can calculate the luminance decrement for each pixel based on the extracted voltage-luminance characteristic parameter. For example, the voltage-luminance characteristic parameter for each pixel includes a threshold voltage of an OLED included in the pixel and a voltage-luminance characteristic coefficient of the pixel. The voltage-luminance characteristic storing unit can store respective voltage-luminance characteristic parameters for all of the pixels included in the OLED display, and can calculate the luminance decrement for each of the all pixels based at least in part on the respective voltage-luminance characteristic parameters, thereby improving the accuracy of the luminance decrement for each pixel.

The OLED display can increase the emission duty with respect to each pixel based at least in part on the luminance decrement (S150). The OLED display can increase the emission duty substantially proportional to the luminance decrement. That is, the OLED display can increase the emission duty as the luminance decrement increases, or as a luminance of each pixel is decreased by the voltage drop of the power supply voltage.

In some embodiments, as illustrated in FIG. 4, the OLED display increases the emission duty such that, with respect to each pixel, a multiplication 430 of a luminance LDROP decreased by the luminance decrement ΔL from the reference luminance LREF by the increased emission duty DUTYDROP is substantially the same as a multiplication 410 of the reference luminance LREF and a reference emission duty DUTYREF. Accordingly, in some embodiments, since the emission duty of each pixel or the ratio of the emission period to the frame period is increased (such that the multiplication of the luminance of each pixel by the emission duty is maintained), although the luminance of the pixel is decreased by the voltage drop ΔV of the power supply voltage, a luminance or an average luminance during one frame period perceived by a viewer is not decreased and is maintained. Further, since the luminance decrement ΔL for each of all the pixels is calculated, and the multiplications 430 of the luminance LDROP of by the emission duty DUTYDROP with respect to the plurality of pixels are substantially the same as the multiplication 410 of the reference luminance LREF by the reference emission duty DUTYREF, luminance deviations between the plurality of pixels can be removed, and the luminance uniformity of the display panel can be improved.

In some embodiments, the OLED display calculates a scale factor for the emission duty based at least in part on the luminance decrement ΔL, and increases the emission duty by multiplying the emission duty by the calculated scale factor with respect to each pixel. For example, the scale factor is calculated by dividing the reference luminance LREF by the luminance LDROP decreased by the luminance decrement ΔL from the reference luminance LREF (i.e., the scale factor=LREF/LDROP). Thus, although the luminance of each pixel is decreased by the voltage drop of the power supply voltage, the multiplication of the luminance of the pixel by the emission duty can be substantially maintained by using the scale factor. Further, since the luminance decrement for each of all the pixels is calculated, and the scale factor for each of all the pixels is calculated, luminance deviations between the pixels can be removed, and the luminance uniformity of the display panel can be improved. In some embodiments, when the scale factor for at least one of the pixels is greater than a predetermined value, or for example when a multiplication of the emission period by the scale factor with respect to at least one pixel is longer than the frame period, the scale factor for all of the pixels is decreased. Accordingly, in some embodiments, even if a margin for compensating the voltage drop of the power supply voltage is insufficient, the luminance uniformity of the display panel does not deteriorate.

The OLED display can drive the pixels based at least in part on the increased emission duty (S170). Since the OLED display increases the emission duty for each pixel (e.g., such that the multiplication of the luminance of each pixel by the emission duty is maintained), and drives the pixels based at least in part on the increased emission duty, the luminance uniformity and the image quality of the display panel can be maintained or improved even if the luminance of each pixel is decreased by the voltage drop of the power supply voltage.

As described above, in the method of operating the OLED display according to example embodiments, the voltage drop of the power supply voltage at each pixel is calculated, the luminance decrement corresponding to the calculated voltage drop is extracted based at least in part on the voltage-luminance characteristic, and the emission duty is increased based at least in part on the luminance decrement. Accordingly, the voltage drop of the power supply voltage can be accurately compensated with respect to each pixel, and the luminance uniformity of the display panel can be improved.

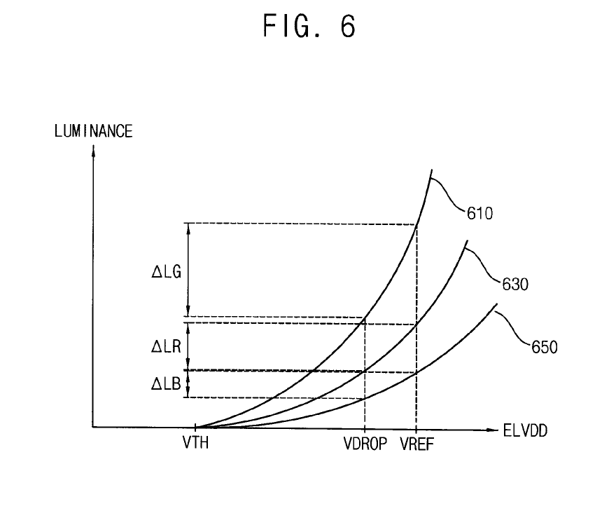

FIG. 5 is a flowchart illustrating a method of operating an OLED display in accordance with example embodiments. FIG. 6 is a diagram for describing an example of extracting a luminance decrement corresponding to a voltage drop of a power supply voltage in a method of FIG. 5.

Referring to FIG. 5, an OLED display calculates a voltage drop (e.g., an IR drop) of a power supply voltage at each pixel based at least in part on image data (S510). According to example embodiments, the OLED display calculates the voltage drop of the power supply voltage at each pixel on a frame-by-frame basis or a subframe-by-subframe basis.

The OLED display can extract luminance decrements corresponding to the voltage drops of the power supply voltage with respect to red, green and blue pixels based at least in part on voltage-luminance characteristics of the red, green and blue pixels, respectively (S530).

For example, as illustrated in FIG. 6, the OLED display extracts the luminance decrement ΔLR for the red pixel by using a first voltage-luminance characteristic curve 630 representing the voltage-luminance characteristic of the red pixel. The OLED display can extract the luminance decrement ΔLG for the green pixel by using a second voltage-luminance characteristic curve 610 representing the voltage-luminance characteristic of the green pixel. And the OLED display can extract the luminance decrement ΔLB for the blue pixel by using a third voltage-luminance characteristic curve 650 representing the voltage-luminance characteristic of the blue pixel. In some embodiments, to store the respective voltage-luminance characteristics of the red, green and blue pixels, the OLED display can include a first lookup table that stores the first voltage-luminance characteristic curve 630 representing the voltage-luminance characteristic of the red pixel, a second lookup table that stores the second voltage-luminance characteristic curve 610 representing the voltage-luminance characteristic of the green pixel, and a third lookup table that stores the third voltage-luminance characteristic curve 650 representing the voltage-luminance characteristic of the blue pixel.

The OLED display can increase the emission duties for the red, green and blue pixels based at least in part on the luminance decrements for the red, green and blue pixels, respectively (S550), and can drive the red, green and blue pixels based at least in part on the increased emission duties for the red, green and blue pixels, respectively (S570).

As described above, in the method of operating the OLED display according to example embodiments, the voltage drop of the power supply voltage at each of the red, green and blue pixels is calculated, the luminance decrement corresponding to the calculated voltage drop with respect to each of the red, green and blue pixels can be extracted based at least in part on the voltage-luminance characteristic for each of the red, green and blue pixels, and the emission duty can be increased based at least in part on the luminance decrement. Accordingly, the voltage drop of the power supply voltage can be accurately compensated with respect to each of the red, green and blue pixels, and the luminance uniformity of the display panel can be improved. Further, the method of operating the OLED display according to example embodiments can be applied to the OLED display where substantially the same power supply voltage is supplied to the red, green and blue pixels or the OLED display where different power supply voltages are supplied to the red, green and blue pixels.

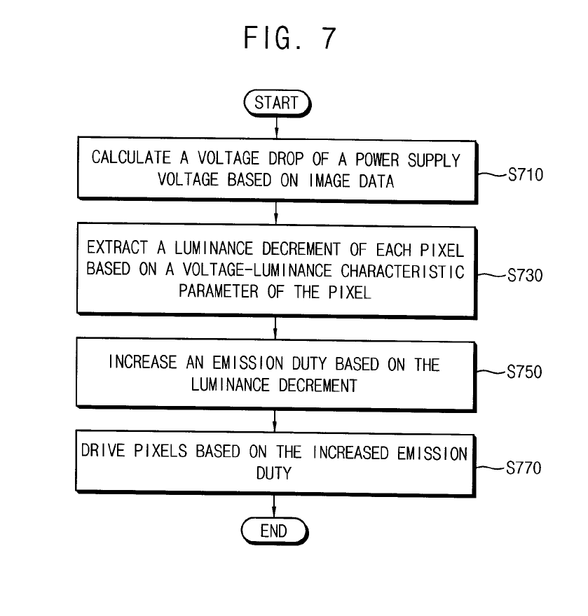

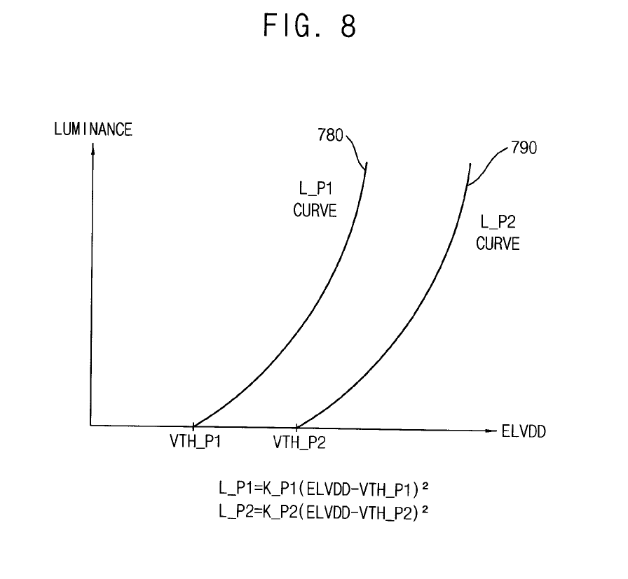

FIG. 7 is a flowchart illustrating a method of operating an OLED display in accordance with example embodiments. FIG. 8 is a diagram for describing an example of extracting a luminance decrement corresponding to a voltage drop of a power supply voltage in a method of FIG. 7.

Referring to FIG. 7, an OLED display calculate a voltage drop of a power supply voltage at each pixel based at least in part on image data (S710), and extracts a luminance decrement of the pixel based at least in part on a voltage-luminance characteristic parameter of the pixel (S730). In some embodiments, the OLED display includes a voltage-luminance characteristic storing unit that stores the voltage-luminance characteristic parameters of respective pixels. For example, the voltage-luminance characteristic storing unit stores the voltage-luminance characteristic parameters respectively corresponding to all the pixels included in the OLED display. In some embodiments, the voltage-luminance characteristic parameter of each pixel can include a threshold voltage of the OLED included in the pixel and a voltage-luminance characteristic coefficient of the pixel. The OLED display can extract the voltage-luminance characteristic parameter of each pixel from the voltage-luminance characteristic storing unit, and can calculate the luminance decrement of the pixel based at least in part on the voltage-luminance characteristic parameter of the pixel.

For example, referring to FIG. 8, the voltage-luminance characteristic storing unit stores, as the voltage-luminance characteristic parameter of a first pixel corresponding to a voltage-luminance characteristic curve 780 of the first pixel, a threshold voltage VTH_P1 of an OLED included in the first pixel and a voltage-luminance characteristic coefficient K_P1 of the first pixel. Also, referring to FIG. 8, the voltage-luminance characteristic storing unit stores, as the voltage-luminance characteristic parameter of a second pixel corresponding to a voltage-luminance characteristic curve 790 of the second pixel, a threshold voltage VTH_P2 of an OLED included in the second pixel and a voltage-luminance characteristic coefficient K_P2 of the second pixel. The OLED display can calculate the luminance decrement by using an equation, “L=K*(ELVDD−VTH)̂2”, where L represents a luminance of each pixel, K represents a voltage-luminance characteristic coefficient of each of each pixel, ELVDD represents the power supply voltage, and VTH represents a threshold voltage of an OLED included in each pixel. For example, the OLED display calculates the luminance decrement of the first pixel by calculating both of a luminance of the first pixel when the power supply voltage ELVDD is a reference power supply voltage and a decreased luminance of the first pixel when the power supply voltage ELVDD is dropped by using an equation, “L_P1=K_P1*(ELVDD−VTH_P1)̂2”. Also, for example, the OLED display calculates the luminance decrement of the second pixel by calculating both of a luminance of the second pixel when the power supply voltage ELVDD is the reference power supply voltage and a decreased luminance of the second pixel when the power supply voltage ELVDD is dropped by using an equation, “L_P2=K_P2*(ELVDD−VTH_P2)̂2”. As described above, since the luminance decrements for the respective pixels are calculated based at least in part on the voltage-luminance characteristic parameters respectively corresponding to all the pixels included in the OLED display, the luminance decrements for the respective pixels caused by the voltage drop of the power supply voltage can be accurately extracted.

The OLED display can increase the emission duty for each pixel based at least in part on the luminance decrement for each pixel (S750), and can drive the pixels based on the increased emission duty (S770).

As described above, in the method of operating the OLED display according to example embodiments, the voltage drop of the power supply voltage at each pixel is calculated, the luminance decrement corresponding to the calculated voltage drop is extracted based at least in part on the voltage-luminance characteristic parameters respectively corresponding to all the pixels included in the OLED display, and the emission duty is increased based at least in part on the luminance decrement. Accordingly, the voltage drop of the power supply voltage for each pixel can be accurately compensated, and the luminance uniformity of the display panel can be improved.

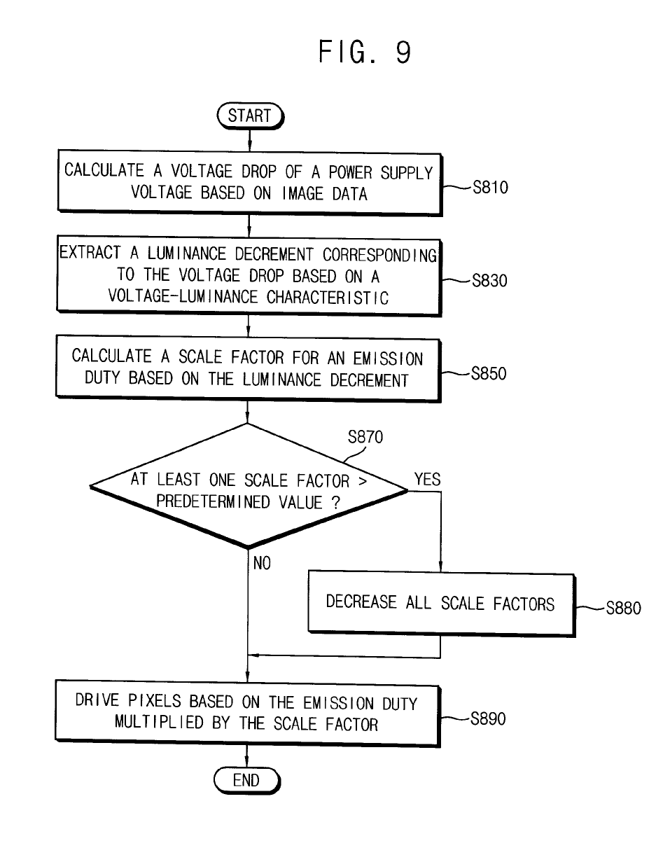

FIG. 9 is a flowchart illustrating a method of operating an OLED display in accordance with example embodiments.

Referring to FIG. 9, an OLED display calculates a voltage drop of a power supply voltage at each pixel based at least in part on image data (S810). Referring to FIG. 9, the OLED display extracts a luminance decrement corresponding to the voltage drop of the power supply voltage based at least in part on a voltage-luminance characteristic of a plurality of pixels (S830).

The OLED display can calculate, with respect to each pixel, a scale factor for an emission duty based at least in part on the luminance decrement (S850). In some embodiments, the scale factor is calculated by dividing a reference luminance by a luminance decreased by the luminance decrement from the reference luminance. When all scale factors for the pixels are less than or substantially equal to a predetermined value (S870: NO), the OLED display can increase the emission duty by multiplying the emission duty by the calculated scale factor with respect to each pixel, and can drive the pixels based at least in part on the emission duty multiplied by the scale factor (S890).

When the scale factor for at least one of the pixels is greater than the predetermined value (S870: YES), the OLED display can decrease the all scale factors for the pixels with substantially the same rate (S880). The OLED display can drive the pixels based at least in part on the emission duty multiplied by the decreased scale factor (S890). Accordingly, in some embodiments, even if a margin for compensating the voltage drop of the power supply voltage is insufficient, the luminance uniformity of the display panel is not deteriorated.

FIG. 10 is a block diagram illustrating an OLED display in accordance with example embodiments.

Referring to FIG. 10, an OLED display 900 includes a display panel 910 having a plurality of pixels, a driving unit or driver 920, a power supply unit 950 and a timing controller 960. The OLED display 900 can be a digital driving type OLED display that produces grayscale values by adjusting an emission duty according to the image data.

The display panel 910 can be coupled to a data driver 930 included in the driving unit 920 through a plurality of data lines, and can be coupled to a scan driver 940 included in the driving unit 920 through a plurality of scan lines. The display panel 910 can include the pixels PX located at the crossing points of the data lines and the scan lines.

The driving unit 920 includes the data driver 930 and the scan driver 940. The data driver 930 can apply a data signal (e.g., one of a high data voltage and a low data voltage) to each pixel through the data line. The scan driver 940 can apply a scan signal to each pixel through the scan line.

The power supply unit 950 can apply a power supply voltage ELVDD to the pixels included in the display panel 910. OLEDs can emit light based at least in part on the power supply voltage ELVDD. The power supply voltage ELVDD provided to the display panel 910 can have different voltage levels at the respective pixels because of a voltage drop of the power supply voltage ELVDD at a power supply line. Accordingly, in a typical OLED display, luminance deviations can occur between the pixels.

The timing controller 960 can control an operation of the OLED display 900. For example, the timing controller 960 provides predetermined control signals to the data driver 930 and the scan driver 940 to control the operation of the OLED display 900. The timing controller 960 can include a data converting unit or data converter 970 that performs a gamma correction operation, a data converting operation and a voltage drop compensation operation for removing the luminance deviations between the pixels. In some embodiments, the data converting unit 970 includes a voltage drop (e.g., IR drop) calculating unit or voltage drop calculator 975, a voltage-luminance characteristic storing unit 980 and an emission duty adjusting unit or an emission duty adjuster 990.

The voltage drop calculating unit 975 can calculate the voltage drop of the power supply voltage ELVDD at each pixel based at least in part on the image data (e.g., the image data after the gamma correction operation is performed).

The voltage-luminance characteristic storing unit 980 can store a voltage-luminance characteristic of the pixels. In some embodiments, the voltage-luminance characteristic storing unit 980 includes a lookup table that stores the voltage-luminance characteristic of the pixels. In some embodiments, the voltage-luminance characteristic storing unit 980 includes a first lookup table that stores the voltage-luminance characteristic of a red pixel, a second lookup table that stores the voltage-luminance characteristic of a green pixel, and a third lookup table that stores the voltage-luminance characteristic of a blue pixel. In some embodiments, the voltage-luminance characteristic storing unit 980 stores a voltage-luminance characteristic parameter for each of the pixels.

The emission duty adjusting unit 990 can extract a luminance decrement corresponding to the voltage drop of the power supply voltage ELVDD with respect to each pixel based at least in part on the voltage-luminance characteristic. The emission duty adjusting unit 990 can increase the emission duty with respect to each pixel based on the luminance decrement. In some embodiments, the emission duty adjusting unit 990 increases the emission duty such that, which respect to each pixel, a multiplication of a luminance decreased by the luminance decrement by the increased emission duty is substantially the same as a multiplication of a reference luminance and a reference emission duty. To achieve this, the emission duty adjusting unit 990 can calculate a scale factor for the emission duty by dividing the reference luminance by the luminance decreased by the luminance decrement from the reference luminance, and can increase the emission duty by multiplying the emission duty by the calculated scale factor with respect to each pixel.

The driving unit 920 can drive the pixels based at least in part on the increased emission duty. Accordingly, even if the luminance deviations between the pixels are caused by the voltage drop of the power supply voltage ELVDD, since the emission duty of each pixel is increased to compensate the luminance decrement of each pixel, the luminance deviations between the plurality of pixels can be removed, and the luminance uniformity of the display panel 910 can be improved.

Although FIG. 10 illustrates an example where the voltage drop calculating unit 975, the voltage-luminance characteristic storing unit 980 and the emission duty adjusting unit 990 are included in the timing controller 960. In some embodiments, at least a portion of the voltage drop calculating unit 975, the voltage-luminance characteristic storing unit 980 and the emission duty adjusting unit 990 are located outside the timing controller 960.

FIG. 11 is a block diagram illustrating an electronic device including an OLED display in accordance with example embodiments.

Referring to FIG. 11, an electronic device 1000 includes a processor 1010, a memory device 1020, a storage device 1030, an input/output (I/O) device 1040, a power supply 1050, and an OLED display 1060. The electronic device 1000 can further include a plurality of ports for communicating a video card, a sound card, a memory card, a universal serial bus (USB) device, other electric devices, etc.

The processor 1010 can perform various computing functions. The processor 1010 can be a microprocessor, a central processing unit (CPU), etc. The processor 1010 can be coupled to other components via an address bus, a control bus, a data bus, etc. Further, in some embodiments, the processor 1010 is coupled to an extended bus such as a peripheral component interconnection (PCI) bus.

The memory device 1020 can store data for operations of the electronic device 1000. For example, the memory device 1020 includes at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano-floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile dynamic random access memory (mobile DRAM) device, etc.

The storage device 1030 can be a solid state drive device, a hard disk drive device, a CD-ROM device, etc. The I/O device 1040 can be an input device such as a keyboard, a keypad, a mouse, a touch screen, etc, and an output device such as a printer, a speaker, etc. The power supply 1050 can supply power for operations of the electronic device 1000.

The OLED display 1060 can be a digital driving type OLED display that produces grayscale values by adjusting an emission duty according to image data. The OLED display 1060 can calculate a voltage drop of a power supply voltage at each pixel, can extract a luminance decrement corresponding to the voltage drop based at least in part on a voltage-luminance characteristic, and can increase an emission duty based at least in part on the luminance decrement, thereby improving luminance uniformity of a display panel.

The described technology can be applied to any electronic device 1000 including the OLED display 1060. For example, the described technology can be applied to televisions, computer monitors, laptop computers, digital cameras, cellular phones, smartphones, personal digital assistants (PDAs), portable multimedia players (PMPs), MP3 players, navigation systems, video phones, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of operating an organic light-emitting diode (OLED) display that includes a plurality of pixels each including a pixel circuit and produces grayscale values by adjusting an emission duty based at least in part on image data, the method comprising:
calculating a voltage drop of a power supply voltage at each of the pixel circuits based at least in part on the image data;
extracting a luminance decrement corresponding to the voltage drop for each pixel circuit based at least in part on a voltage-luminance characteristic of the pixels;
increasing the emission duty for each pixel based at least in part on the luminance decrement; and
driving the pixels based at least in part on the increased emission duty.

2. The method of claim 1, wherein the emission duty is increased to be substantially proportional to the luminance decrement.

3. The method of claim 1, wherein the emission duty is increased such that a product of a luminance decreased by the luminance decrement and the increased emission duty is substantially the same as a product of a reference luminance and a reference emission duty for each pixel.

4. The method of claim 1, wherein the calculating includes:
dividing a display panel of the OLED display into a plurality of blocks;
calculating a plurality of currents respectively provided to the blocks based at least in part on the image data;
calculating the voltage drop at each of the blocks based at least in part on the currents; and
interpolating the calculated voltage drop at each block so as to calculate the voltage drop at each pixel circuit.

5. The method of claim 1, wherein the voltage drop is calculated on a frame-by-frame basis.

6. The method of claim 1, wherein the voltage drop is calculated on a subframe-by-subframe basis.

7. The method of claim 1, wherein the extracting includes obtaining the luminance decrement corresponding to the voltage drop from a lookup table storing the voltage-luminance characteristic.

8. The method of claim 1, wherein the extracting includes:
obtaining a first luminance decrement corresponding to the voltage drop of a red pixel among the pixels from a first lookup table storing the voltage-luminance characteristic of the red pixel;
obtaining a second luminance decrement corresponding to the voltage drop of a green pixel among the pixels from a second lookup table storing the voltage-luminance characteristic of the green pixel; and
obtaining a third luminance decrement corresponding to the voltage drop of a blue pixel among the pixels from a third lookup table storing the voltage-luminance characteristic of the blue pixel.

9. The method of claim 1, wherein the extracting includes:
extracting a voltage-luminance characteristic parameter for each pixel from a voltage-luminance characteristic storing unit that stores the voltage-luminance characteristic parameter for each pixel; and
calculating the luminance decrement for each pixel based at least in part on the extracted voltage-luminance characteristic parameter for each pixel.

10. The method of claim 9, wherein each pixel includes an OLED, and wherein, for each pixel, the voltage-luminance characteristic parameter includes a threshold voltage of the OLED and a voltage-luminance characteristic coefficient of each pixel.

11. The method of claim 9, wherein the luminance decrement for each pixel is calculated using an equation, “L=K*(ELVDD−VTH)̂2”, where L represents a luminance of each pixel, K represents a voltage-luminance characteristic coefficient of each pixel, ELVDD represents the power supply voltage, and VTH represents a threshold voltage of an OLED included in each pixel.

12. The method of claim 1, wherein the increasing includes:
calculating a scale factor for the emission duty based at least in part on the luminance decrement; and
multiplying the emission duty by the calculated scale factor with respect to each pixel so as to increase the emission duty.

13. The method of claim 12, further comprising dividing a reference luminance by a luminance, decreased by the luminance decrement, so as to calculate the scale factor.

14. The method of claim 12, wherein the increasing further includes, when the scale factor for at least one of the pixels is greater than a predetermined value, decreasing the scale factor for all of the pixels.

15. An organic light-emitting diode (OLED) display, comprising:
a display panel including a plurality of pixels each including a pixel circuit;
a voltage drop calculator configured to calculate a voltage drop of a power supply voltage at each pixel circuit based at least in part on image data;
a voltage-luminance characteristic storing unit configured to store a voltage-luminance characteristic of the pixels;
an emission duty adjuster configured to i) extract a luminance decrement corresponding to the voltage drop of the power supply voltage with respect to each pixel circuit based at least in part on the voltage-luminance characteristic and ii) increase the emission duty with respect to each pixel based at least in part on the luminance decrement; and
a driver configured to drive the pixels based at least in part on the increased emission duty.

16. The OLED display of claim 15, wherein the emission duty adjuster is further configured to increase the emission duty such that, with respect to each pixel, a product of a luminance decreased by the luminance decrement and the increased emission duty is substantially the same as a product of a reference luminance and a reference emission duty.

17. The OLED display of claim 15, wherein the voltage-luminance characteristic storing unit includes a lookup table configured to store the voltage-luminance characteristic of the pixels.

18. The OLED display of claim 15, wherein the pixels include red, green, and blue pixels, and wherein the voltage-luminance characteristic storing unit includes:
a first lookup table configured to store a first voltage-luminance characteristic of the red pixels;
a second lookup table configured to store a second voltage-luminance characteristic of the green pixels; and
a third lookup table configured to store a third voltage-luminance characteristic of the blue pixels.

19. The OLED display of claim 15, wherein the voltage-luminance characteristic storing unit is further configured to store a voltage-luminance characteristic parameter for each pixel.

20. The OLED display of claim 15, wherein the emission duty adjuster is further configured to i) calculate a scale factor of the emission duty based at least in part on the luminance decrement and ii) multiply the emission duty by the calculated scale factor with respect to each pixel so as to increase the emission duty.
